(19) United States
(12) Patent Application Publication
(10) Pub. No.: US 2012/0131682 A1
(43) Pub. Date: May 24, 2012

(54) METHOD AND APPARATUS FOR PROTECTING DIGITAL CONTENTS

(75) Inventors: Jae Chul KIM, Daejeon (KR); Seong Ho Lee, Daejeon (KR); Yoon Seop Chang, Daejeon (KR); Kyung Ok Kim, Daejeon (KR); Chang Rak Yoon, Daejeon (KR); Hak Cheol Kim, Daejeon (KR); Ki Jung Lee, Yongin-si (KR); Sung Woong Shin, Daejeon (KR)

(73) Assignee: Electronics and Telecommunications Research Institute, Daejeon (KR)

(21) Appl. No.: 13/285,220

(22) Filed: Oct. 31, 2011

(30) Foreign Application Priority Data
Nov. 23, 2010 (KR) 10-2010-0117086

(51) Int. Cl. G06F 21/24

(52) U.S. Cl. 726/28

(57) ABSTRACT

The present invention discloses an apparatus and method for protecting digital spatial information. The apparatus for protecting digital spatial information according to the present invention includes a spatial information authority database which stores access authority information on spatial information, an access authority determining unit which, when there is a request for access to the spatial information from a user, determines whether to permit the user to access the requested spatial information by referring to the spatial information authority database, a spatial information database, a spatial information providing unit which obtains the access-permitted spatial information from the spatial information database, organizes the information based on the user's request for access, and provides the information, and an access control unit.

### CROSS-REFERENCE TO RELATED PATENT APPLICATION

This application claims the benefit of Korean Patent Application No. 10-2010-0117086, filed on Nov. 23, 2010, in the Korean Intellectual Property Office, the disclosure of which is incorporated herein in its entirety by reference.

### BACKGROUND OF THE INVENTION

1. Field of the Invention

The present invention relates to a method and apparatus for protecting digital spatial information, i.e., digital contents, and more particularly, to a method and apparatus for protecting digital contents, which can safely protect the digital contents even during distribution.

2. Description of the Related Art

Digital rights management (DRM) is generally used to manage the copyright of digital contents. The DRM is a commercial product and service, which applies a content protection technique to prevent illegal distribution and copy of various digital contents such as e-books, music, videos, games, software, stock information, images, etc. and manages earnings which are generated by the use of the protected contents to return to the person directly involved in the copyright.

The current copyright protection technologies may be divided into an encryption technology which provides a secret key to a normal user and a watermarking technology which adds copyright information to the contents to track possible illegal uses. Meanwhile, a digital rights management (DRM) solution has been also developed as a complex concept of the two technologies.

The DRM solution is not intended to prevent the content from being copied but intended to allow the copy of the content and make a charge for the use of the corresponding content. For example, when a user wants to transmit an MP3 file purchased online to his/her friend, there is no problem in transmitting the MP3 file, but his/her friend has to pay for the use of the corresponding MP3 file. Under the condition that it is impossible to perfectly prevent the copy of the digital contents, the DRM solution has attracted much attention as a convenient and practical solution.

Meanwhile, the utilization of digital contents has increased and, particularly, the distribution of spatial information such as map data has expanded from the public sector to the private sector. However, since the DRM technology is to control the content itself, a user who possesses the downloaded content can freely distribute the content. Therefore, various technologies intended to illegally remove the DRM and allow users to use the contents have also been developed.

Therefore, it is necessary to provide a copyright protection method which can protect the content even when the content is illegally distributed and the copyright protection is removed. Particularly, it is necessary to develop a method which can safely protect the content, which contains confidential information and may be exposed to a web environment that anyone can easily access, during the distribution of the content.

### SUMMARY OF THE INVENTION

The present invention has been made in an effort to solve the above-described problems associated with prior art, and an object of the present invention is to provide an apparatus for protecting digital spatial information, which can protect the spatial information content itself and safely protect the content even when a content protection is removed during distribution of the content.

Another object of the present invention is to provide a method for protecting digital spatial information, which can protect the spatial information content itself and safely protect the content even when a content protection is removed during distribution of the content.

According to an aspect of the present invention to achieve the above object of the present invention, there is provided an apparatus for protecting digital spatial information, the apparatus comprising: a spatial information authority database which stores access authority information on spatial information; an access authority determining unit which, when there is a request for access to the spatial information from a user, determines whether to permit the user to access the requested spatial information by referring to the spatial information authority database; a spatial information database which stores the spatial information; a spatial information providing unit which obtains the access-permitted spatial information from the spatial information database, organizes the information based on the user's request for access, and provides the information; and an access control unit which controls an interface between the access authority determining unit, the spatial information providing unit, and the user according to the type of the user's request for access.

The type of the user's request for access may comprise a request for access to spatial information data, a request for access to a spatial information service, and a request for access to previously extracted spatial information data.

The spatial information providing unit may comprise a data providing unit and a service providing unit. Here, when the type of the user's request for access is the request for access to the spatial information data or the request for access to the previously extracted spatial information data, the data providing unit may be activated by the access control unit and, when the type of the user's request for access is the request for access to the spatial information service, the service providing unit may be activated by the access control unit.

The data providing unit may comprise: a data organizing unit which obtains the access-permitted spatial information data from the spatial information database, extracts a predetermined portion from the obtained spatial information data, and organizes the spatial information data based on the user's request for access; and a packaging unit which packages the organized spatial information data. Here, an interface between the data organizing unit and the packaging unit may be controlled by the access control unit.

The data providing unit may further comprise: an extracted spatial information database which stores data randomly extracted in advance from the spatial information database; and an extracted data organizing unit which obtains the spatial information data extracted from the extracted spatial information database and organizes the spatial information data based on the user's request for access. Here, an interface between the extracted data organizing unit and the packaging unit may be controlled by the access control unit.

Here, when the type of the user's request for access is the request for the spatial information data, the data organizing unit may be activated by the access control unit and the packaging unit may package the spatial information data organized by the data organizing unit and, when the type of the user's request for access is the request for the extracted spatial information data, the extracted data organizing unit may be activated by the access control unit and the packaging unit may package the extracted spatial information data organized by the extracted data organizing unit.

The apparatus for protecting the digital spatial information may further comprise a license issuing unit which issues a license to a user in response to the request for access from the user who receives the packaged data. Here, the license issuing unit may comprise: a license issue request receiving unit which receives a request for issuing a license from the user who receives the packaged data; an access authority obtaining unit which obtains authority information on the packaged data with respect to the requesting user from the spatial information authority database; a license generating unit which generates a license by organizing the obtained access authority information as the license; and a license providing unit which provides the generated license to the user.

The service providing unit may comprise: a service configuring unit which obtains spatial information data related to the access-permitted spatial information service from the spatial information database, extracts a predetermined portion from the spatial information service, and configures the spatial information service based on the user's request for access; and a service interface providing unit which provides a service interface for providing the configured spatial information service. Here, an interface between the service configuring unit and the service interface providing unit may be controlled by the access control unit.

The access authority information stored in the spatial information authority database may comprise the authority to access a resource for each user, and the authority to access the resource for each user may comprise a user, at least one resource which is accessible by the user, and an allowable range for access to the resource.

The request for access to the spatial information may comprise: user identification information of a user requesting the access to the spatial information; an operation which indicates a specific action related to manipulation applied to the access-requested spatial information; at least one resource which corresponds to a main target of the access-requested spatial information and is identifiably stored in the spatial information database; and environmental information which indicates a limited search range for the resources.

The access authority determining unit may comprise: an access authority information obtaining unit which obtains corresponding access authority information by referring to the spatial information authority database based on the user identification information and the resources included in the user's request for access; an access authority information judging unit which determines whether to permit the operation included in the request for access by referring to the allowable range for access to the requested resource included in the obtained access authority information; and an access permission determining unit which determines whether to permit the user to access the requested spatial information based on the access permission judgment result.

The spatial information stored in the spatial information database may comprise spatial information data, and the spatial information data may comprise a resource identifiably stored and at least one attribute for the resource.

The spatial information obtained by the data providing unit may be organized based on the request for access in the form of a binary encoding, extensible markup language (XML), geography markup language (GML) or link.

The spatial information data may be packaged by the packaging unit in the form of a binary file, to which digital rights management (DRM) is applied, to prevent illegal copy of the spatial information data organized by the data organizing unit.

The spatial information may comprise map information, and the map information stored in the spatial information database may comprise map identification information, a map related to the identified map information, and information obtained by digitizing positions in the map.

According to another aspect of the present invention to achieve the above object of the present invention, there is provided a method for protecting spatial information data, which is performed in an apparatus for protecting digital spatial information, the method comprising: receiving a request for access to spatial information data from a user; obtaining the user's authority to access the spatial information data corresponding to the user's request for access from a spatial information authority database; determining whether to permit the user to access the requested spatial information data by referring to the obtained access authority and, if it is determined that the requesting user has the authority to access the spatial information data, permitting the user to access the corresponding spatial information data; obtaining the access-permitted spatial information data from the spatial information authority database; organizing the spatial information data by extracting necessary information from the obtained spatial information data based on the user's request for access; packaging the organized data to be protected; and transmitting the packaged data to the user.

According to still another aspect of the present invention to achieve the above object of the present invention, there is provided a method for protecting a spatial information service, which is performed in an apparatus for protecting digital spatial information, the method comprising: receiving a request for access to a spatial information service from a user; obtaining the user's authority to access the spatial information service corresponding to the user's request for access from a spatial information authority database; determining whether to permit the user to access data related to the requested spatial information service by referring to the obtained access authority and, if it is determined that the requesting user has the authority to access the spatial information service, permitting the user to access the corresponding spatial information service; obtaining data related to the access-permitted spatial information service from the spatial information authority database; configuring a necessary information service using the obtained spatial information data based on the user's request for access; and providing the configured service to the user.

According to yet another aspect of the present invention to achieve the above object of the present invention, there is provided a method for protecting previously extracted spatial information data, which is performed in an apparatus for protecting digital spatial information, the method comprising: receiving a request for access to previously extracted spatial information data from a user; obtaining the previously extracted spatial information data corresponding to the user's request to access from a spatial information authority database and organizing the previously extracted spatial information data based on the user's request for access; packaging the organized data to be protected; and transmitting the packaged data to the user.

According to still yet another aspect of the present invention to achieve the above object of the present invention, there is provided a method for issuing a license to a user, which is performed in an apparatus for protecting digital spatial information, the method comprising: receiving a request for issuing a license for access to spatial information from a user who receives the spatial information from the apparatus for protecting the digital spatial information; obtaining access authority information on the spatial information provided to the user from a spatial information authority database; generating a license by organizing the obtained access authority information as the license; and providing the generated license to the user.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic block diagram showing the configuration of an apparatus for protecting spatial information in accordance with an exemplary embodiment of the present invention;

FIG. 2A is a block diagram showing the configuration of an access authority determining unit in an apparatus for protecting spatial information in accordance with an exemplary embodiment of the present invention;

FIG. 2B is a block diagram showing the configuration of a spatial information providing unit in an apparatus for protecting spatial information in accordance with an exemplary embodiment of the present invention;

FIG. 3 is a schematic block diagram showing the configuration of an apparatus for protecting spatial information data in accordance with another exemplary embodiment of the present invention;

FIG. 4 is a block diagram showing the configuration of a license issuing unit in an apparatus for protecting spatial information data in accordance with another exemplary embodiment of the present invention;

FIG. 5 is a sequence chart showing the flow and processing of data in an apparatus for protecting spatial information data in accordance with another exemplary embodiment of the present invention;

FIG. 6 is a schematic block diagram showing the configuration of an apparatus for protecting a spatial information service in accordance with still another exemplary embodiment of the present invention;

FIG. 7 is a sequence chart showing the flow and processing of data in an apparatus for protecting a spatial information service in accordance with still another exemplary embodiment of the present invention;

FIG. 8 is a block diagram showing the configuration of an apparatus for providing previously extracted spatial information data in accordance with yet another exemplary embodiment of the present invention; and

FIG. 9 is a sequence chart showing the flow and processing of data in an apparatus for providing previously extracted spatial information data in accordance with yet another exemplary embodiment of the present invention.

### DETAILED DESCRIPTION OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B etc. may be used herein to describe various elements, these elements should not be limited by these terms. These terms are only used to distinguish one element from another. For example, a first element could be termed a second element, and similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings. Like reference numerals in the drawings denote like elements, and thus repeated descriptions will be omitted.

The present invention discloses a method and apparatus for safely protecting digital spatial information, i.e., digital contents when the digital contents are distributed to users. In particular, the apparatus for protecting the digital spatial information according to the present invention adopts a protection technology for the digital content itself provided to a user and, at the same time, an access control technology for the user who requests the digital content, thereby doubly protecting the spatial information.

The digital spatial information according to the present invention comprise a variety of digital information, distributed in a virtual space, such as digital documents, digital moving pictures, digital audio files, digitized information from analog data, map information, etc.

While an apparatus for protecting map information is illustrated in an exemplary embodiment of the present invention, the spatial information according to the present invention is not limited to map information.

The apparatus for protecting the spatial information according to the present invention may operate on a separate computer hardware server for each component in a distributed network environment or may operate as an individual module on a single computer hardware server. Moreover, the apparatus may be operated in a single module using different program codes.

The apparatus for protecting the spatial information according to the present invention provides a preferred interface between processes for protecting the spatial information and is not limited to the configurations according to the exemplary embodiments of the present invention.

Next, with regard to the apparatus and method for protecting the spatial information in accordance with the present invention, the overall configuration of the apparatus for protecting the spatial information will be described first. According to the exemplary embodiments of the present invention, the spatial information may be provided in the form of data or service, and thus, the configuration and process of the apparatus for protecting the spatial information will be described based on the type of spatial information provided.

Configuration of Apparatus for Protecting Spatial Information

Next, the overall configuration of an apparatus for protecting spatial information of the present invention will be described.

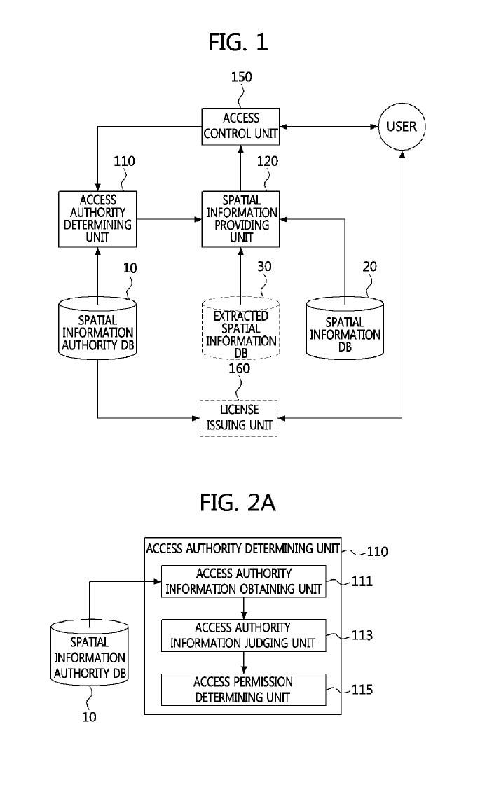

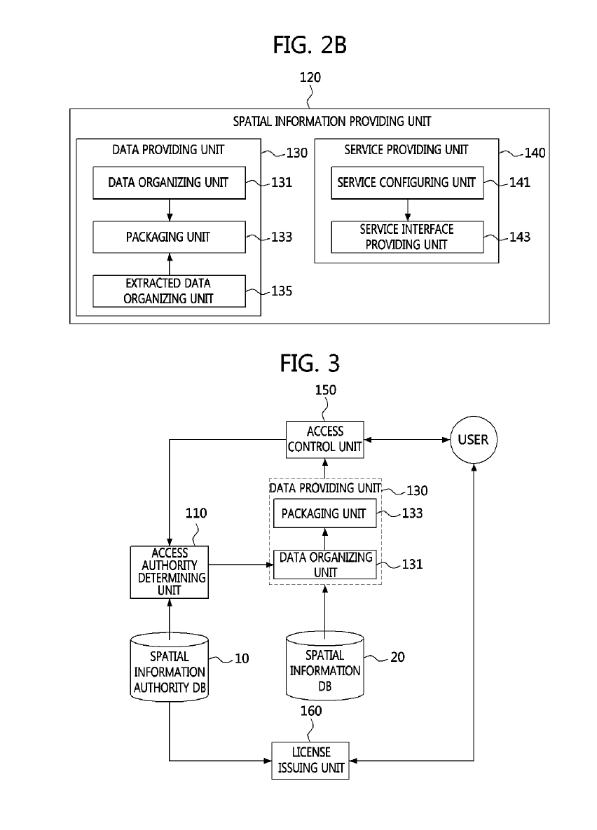

FIG. 1 is a schematic block diagram showing the configuration of an apparatus for protecting spatial information in accordance with an exemplary embodiment of the present invention, FIG. 2A is a block diagram showing the configuration of an access authority determining unit in the apparatus for protecting the spatial information in accordance with an exemplary embodiment of the present invention, and FIG. 2B is a block diagram showing the configuration of a spatial information providing unit in the apparatus for protecting the spatial information in accordance with an exemplary embodiment of the present invention.

Referring to FIG. 1, it can be seen that the apparatus for providing the spatial information in accordance with an exemplary embodiment of the present invention comprises a spatial information authority database 10, a spatial information database 20, an extracted spatial information database 30, an access authority determining unit 110, a spatial information providing unit 120, an access control unit 150, and a license issuing unit 160.

Referring to FIG. 2A, it can be seen that the access authority determining unit 110 in accordance with an exemplary embodiment of the present invention comprises an access authority information obtaining unit 111, an access authority information judging unit 113, and an access permission determining unit 115.

Referring to FIG. 2B, it can be seen that the spatial information providing unit 120 in accordance with an exemplary embodiment of the present invention comprises a data providing unit 130, and a service providing unit 140, the data providing unit 130 comprises a data organizing unit 131, a packaging unit 133, and an extracted data organizing unit 135, and the service providing unit 140 comprises a service configuring unit 141 and a service interface providing unit 143.

Referring to FIGS. 1, 2A and 2B, the configuration of the apparatus for providing the spatial information in accordance with an exemplary embodiment of the present invention may be described as follows.

Access authority information on spatial information is stored in the spatial information authority database 10.

When there is a request for access to spatial information from a user, the access authority determining unit 110 determines whether to permit the user to access the requested spatial information by referring to the spatial information authority database 10. The access authority determining unit 110 may comprise the access authority information obtaining unit 111, the access authority information judging unit 113, and the access permission determining unit 115.

The access authority information obtaining unit 111 obtains corresponding access authority information by referring to the spatial information authority database 10 based on user identification information and resource included in the user's request for access.

The access authority information judging unit 113 determines whether to permit an operation included in the request for access by referring to an allowable range included in the obtained access authority information.

The access permission determining unit 115 determines whether to permit the user to access the requested spatial information data based on the access permission judgment result.

The spatial information database 20 stores data related to the spatial information. The spatial information data related to the spatial information includes a resource identifiably stored and at least one attribute for the resource.

The extracted spatial information database 30 stores spatial information data previously extracted for each user from the spatial information authority database 10.

The spatial information providing unit 120 includes the data providing unit 130 for providing spatial information data and the service providing unit 140 for providing a spatial information service. One of the data providing unit 130 and the service providing unit 140 is activated under the control of the access control unit 150 depending on whether the information requested by the user is data or service.

That is, when the user requests the spatial information data, the data providing unit 130 is activated to provide the requested data to the user. Otherwise, when the user requests the spatial information service, the service providing unit 140 is activated to provide the requested service to the user.

The data providing unit 130 comprises the data organizing unit 131, the extracted data organizing unit 135, and the packaging unit 133. The data organizing unit 131 obtains the spatial information data corresponding to the user's request for access from the spatial information database 20 and organizes the spatial information data based on the user's request for access. The extracted data organizing unit 135 obtains the previously extracted spatial information data corresponding to the user's request for access from the extracted spatial information database 30 and organizes the spatial information data based on the user's request for access. The packaging unit 133 packages the organized spatial information data.

Meanwhile, the service providing unit 140 comprises the service configuring unit 141 and the service interface providing unit 143. To provide the spatial information service corresponding to the user's request for access, the service configuring unit 141 obtains data related to the requested service from the spatial information database 20 and configuring the service based on the user's request for access.

The service interface providing unit 143 provides a service interface for providing the configured spatial information service.

The access control unit 150 allocates the request for access to the spatial information data from the user, controls the activation of the data providing unit 130 and the service providing unit 140, and controls an interface between the data organizing unit 131, the packaging unit 133, the service configuring unit 141, and the service interface providing unit 143.

In response to the request for access from the user who receives the packaged data generated by the packaging unit 133, the license issuing unit 160 issues a license to the user such that the user can access the packaged spatial information data.

Configuration and Operation of Apparatus for Protecting Spatial Information Data

Next, the configuration and operation of an apparatus for protecting spatial information data in response to a user's request for the spatial information data will be described in detail.

Particularly, a user in this exemplary embodiment may have the authority to modify and edit the spatial information data or generate new spatial information data as well as the authority to access and obtain the spatial information data. With regard to this, the configuration of the apparatus for identifying the user's authority and protecting the spatial information data will be described below.

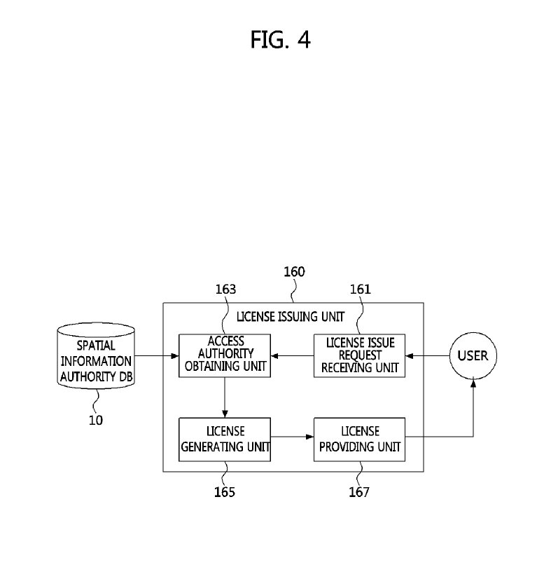

FIG. 3 is a schematic block diagram showing the configuration of an apparatus for protecting spatial information data in accordance with another exemplary embodiment of the present invention, and FIG. 4 is a block diagram showing the configuration of a license issuing unit in an apparatus for protecting spatial information data in accordance with another exemplary embodiment of the present invention.

Referring to FIG. 3, it can be seen that an apparatus for providing spatial information data in accordance with another exemplary embodiment of the present invention comprises a spatial information authority database 10, a spatial information database 20, an access authority determining unit 110, a data providing unit 130, an access control unit 150, and a license issuing unit 160. It can be also seen that the data providing unit 130 comprises a data organizing unit 131 and a packaging unit 133.

Referring to FIG. 4, it can be seen that the license issuing unit 160 comprises a license issue request receiving unit 161, an access authority obtaining unit 163, a license generating unit 165, and a license providing unit 167.

Next, referring to FIGS. 3 and 4, the configuration of the apparatus for providing the spatial information data in accordance with another exemplary embodiment of the present invention may be described. The function and role of each component of the apparatus will be described in detail.

Access authority information on spatial information is stored in the spatial information authority database 10. The access authority information may include a resource accessible by each user and an allowable range for the resources. The allowable range may include, for example, the authority to refer to the resource, the authority to edit the resource, the authority to modify the resource, the authority to generate the resource, etc.

When there is a request for access to spatial information data from a user, the access authority determining unit 110 determines whether to permit the user to access the requested spatial information data by referring to the spatial information authority database 10.

The user's request for access to the spatial information data may include user identification information, operations, resources, and environmental information. The user identification information is used to identify the requesting user. The operation indicates a specific action related to manipulation applied to the access-requested spatial information data. The resources correspond to a main target of the access-requested spatial information data and are identifiably stored in the spatial information database. The environmental information may indicate a search range for the access-requested resource.

For example, when a user named “Hong Gil-dong” tries to edit data for an area within 5 km from the border in a military secret map from 09:00 to 12:00, the request for access may be configured in the context of “user: Hong Gil-dong, operation: edit, resource: military secret map, environment: within 5 km from the border, from 09:00 to 12:00”.

The access authority information obtaining unit 111 obtains corresponding access authority information by referring to the spatial information authority database 10 based on the user identification information and resource included in the user's request for access. For example, the access authority information obtaining unit 111 obtains information on what resource the user has the authority to access.

The access authority information judging unit 113 determines whether to permit the operation included in the request for access by referring to the allowable range included in the obtained access authority information. For example, the access authority information judging unit 113 determines whether there is the authority to edit the accessible resource or whether there is only the authority to refer to the resource.

The access permission determining unit 115 determines whether to permit the user to access the requested spatial information data based on the access permission judgment result.

When a request for access of “user: Hong Gil-dong, operation: edit, resource: military secret map, environment: within 5 km from the border, 09:00 to 12:00” is received, the access permission determining unit 115 determines whether Hong Gil-dong has the authority to “edit” the “military secret map” and determines whether to permit the access.

The spatial information database 20 stores data related to the spatial information. The spatial information data related to the spatial information includes a resource identifiably stored and at least one attribute for the resource. For example, if the spatial information is map information, the resource may be a military secret map stored in the form of a map, and the attribute may be data obtained by digitizing information on each position in the map.

The data providing unit 130 activated based the user's request for access to the spatial information data comprises the data organizing unit 131 and the packaging unit 133.

The data organizing unit 131 obtains the spatial information corresponding to the user's request for access from the spatial information database 20 and organizes the spatial information data based on the user's request for access.

For example, when a request for access of “user: Hong Gil-dong, operation: edit, resource: military secret map, environment: within 5 km from the border, from 09:00 to 12:00” is received, the data organizing unit 131 obtains the requested military secret map from the spatial information database 20, extracts data for an area within 5 km from the border from the obtained data, and organizes the data in the form of a binary encoding, extensible markup language (XML), geography markup language (GML) or link, and then transmits the data to the access control unit 150.

The packaging unit 133 packages the organized spatial information data. Here, the spatial information data may be packaged by the packaging unit 133 in the form of a binary file, to which digital rights management (DRM) is applied, to prevent illegal copy of the spatial information data organized by the data organizing unit 131.

The packaged spatial information data is provided to the user under the control of the access control unit 150.

The access control unit 150 allocates the request for access to the spatial information data from the user, controls the activation of the data providing unit 130, and controls an interface between the data organizing unit 131 and the packaging unit 133.

That is, for example, when the user's request for access to the spatial information data is a request for data, the access control unit 150 performs a series of control operations such as activating the data providing unit 130, requesting the access authority determining unit 110 to identify the access authority in response to the user's request for access, requesting the packaging unit 133 to package the data organized by the data organizing unit 131, and providing the data packaged by the packaging unit 133 to the user.

In response to the request for access from the user who receives the packaged data generated by the packaging unit 133, the license issuing unit 160 issues a license to the user such that the user can access the packaged spatial information data.

Referring to FIG. 4, it can be seen that the license issuing unit 160 comprises the license issue request receiving unit 161, the access authority obtaining unit 163, the license generating unit 165 and the license providing unit 167.

The license issue request receiving unit 161 receives a request for issuing a license from the user who receives the packaged data. The access authority obtaining unit 163 obtains authority information on the packaged data with respect to the requesting user from the spatial information authority database 10. The license generating unit 165 generates a license by organizing the obtained access authority information as the license. The license providing unit 167 provides the generated license to the user.

The license permits the user to access the packaged spatial information through a user terminal. The license includes information on what authority the user has for the requested resource. For example, if the user has the authority to edit the military secret map, the license contains such information.

Therefore, when the user tries to edit the provided data, the information included in the license is referred to. If the license contains only the authority to refer to the corresponding resource, the user's attempt to edit the data will be rejected.

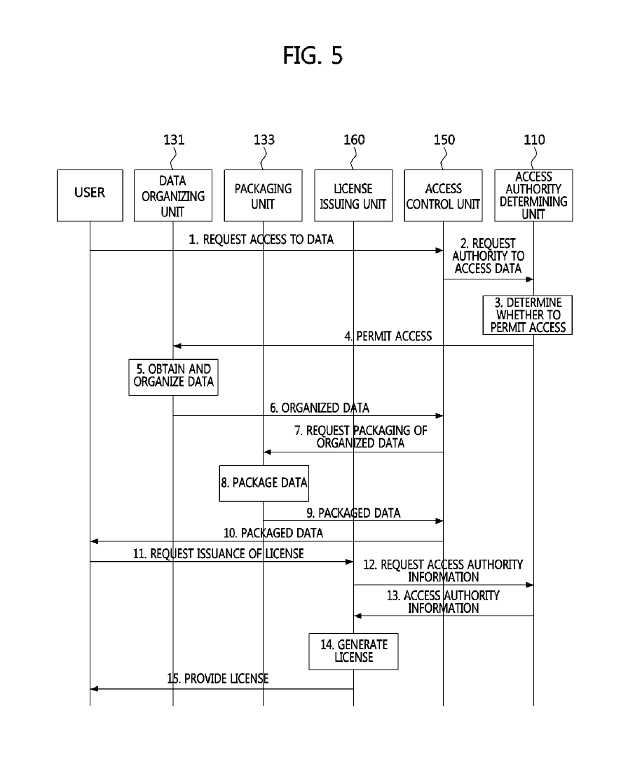

FIG. 5 is a sequence chart showing the flow and processing of data in an apparatus for protecting spatial information data in accordance with another exemplary embodiment of the present invention.

Referring to FIGS. 1 to 5, a process of receiving a request for access to spatial information data from a user and providing the spatial information data to the user in accordance with another exemplary embodiment of the present invention may be described as follows.

When a request for access to spatial information data is received from a user, the access control unit 150 activates the data providing unit 130, forms a context corresponding to the user's request for access, and transmits the context to the access authority determining unit 110. That is, the access control unit 150 inquires whether to permit the user to access the spatial information data requested by the user. Like in the above embodiment, when a user named Hong Gil-dong tries to edit data for an area within 5 km from the border in a military secret map from 09:00 to 12:00, the request for access will be configured in the context of “user: Hong Gil-dong, operation: edit, resource: military secret map, environment: within 5 km from the border, from 09:00 to 12:00”, and transmitted to the access authority determining unit 110.

The access authority determining unit 110, which receives the inquiry on whether to permit the user's request for access from the access control unit 150, refers to the access authority information from the spatial information authority database 10 storing the access authority information and, if the user has the authority to access the requested spatial information data, requests the data organizing unit 131 to obtain the requested data.

Regarding the aforementioned request for access of “user: Hong Gil-dong, operation: edit, resource: military secret map, environment: within 5 km from the border, from 09:00 to 12:00”, the access authority determining unit 110 determines whether Hong Gil-dong has the authority to “edit” the “military secret map”, determines whether to permit the access, and requests the data organizing unit 131 to obtain the data of “resource: military secret map, environment: within 5 km from the border”.

The data organizing unit 131 obtains the access-permitted spatial information data from the spatial information database 20, organizes the data based on the user's request for access, and then returns the data to the access control unit 150. Here, the data may be organized in the form of a binary encoding, extensible markup language (XML), geography markup language (GML) or link.

The access control unit 150 receiving the organized data transmits the context of the user's request for access and the data organized by the data organizing unit 131 to the packaging unit 133 and requests the packaging unit 133 to package the data.

The packaging unit 133 packages the received data and returns the data to the access control unit 150. The access control unit 150 receiving the packaged data transmits the packaged data to the user who requests the access.

Meanwhile, when the user receiving the packaged data requests the license issuing unit 160 to issue a license to use the packaged data, the license issuing unit 160 obtains authority information on the requested user's packaged data from the spatial information authority database 10, generates a license by organizing the obtained authority information as the license, and provides the license to the requesting user.

For example, if the license file contains the authority to edit the data, the user can edit the data for an area within 5 km from the border in the military secret map, which corresponds to the provided resource.

Configuration and Operation of Apparatus for Protecting Spatial Information Service

Next, the configuration and operation of an apparatus for protecting a spatial information service in response to a user's request for the spatial information service will be described in detail.

Unlike the process of providing data, the spatial information service according to the present invention may provide an application service using data together with the spatial information data to the user.

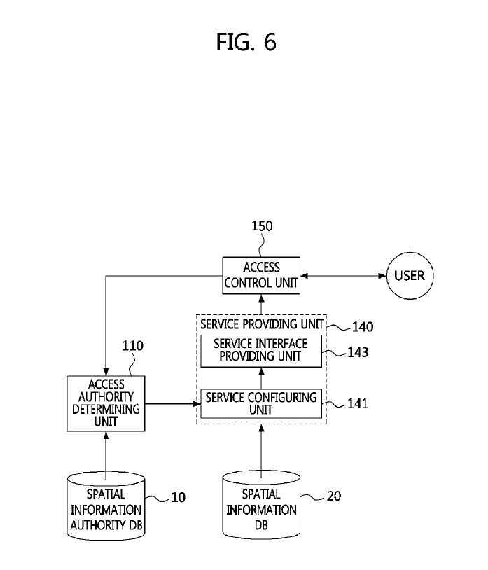

FIG. 6 is a schematic block diagram showing the configuration of an apparatus for protecting a spatial information service in accordance with still another exemplary embodiment of the present invention.

Referring to FIG. 6, it can be seen that the apparatus for providing the spatial information service in accordance with still another exemplary embodiment of the present invention comprises a spatial information authority database 10, a spatial information database 20, an access authority determining unit 110, a service providing unit 140, an access control unit 150, and a license issuing unit 160, and the service providing unit 140 comprises a service configuring unit 141 and a service interface providing unit 143.

Referring to FIG. 6, the configuration of the apparatus for providing the spatial information service in accordance with still another exemplary embodiment of the present invention may be described as follows.

Next, the function and role of each component of the apparatus will be described in detail.

Access authority information on spatial information is stored in the spatial information authority database 10. The access authority information may include a resource accessible by each user and an allowable range for the resource. The allowable range may include, for example, the authority to refer to the resource, the authority to edit the resource, the authority to modify the resource, the authority to generate the resource, etc.

When there is a request for access to a spatial information service from a user, the access authority determining unit 110 determines whether to permit the user to access the requested spatial information service by referring to the spatial information authority database 10.

The user's request for access to the spatial information service may include user identification information, operations, resources and environmental information. The user identification information is used to identify the requesting user. The operation indicates a specific action related to manipulation applied to the access-requested spatial information service. The resources correspond to a main target of the access-requested spatial information service and are identifiably stored in the spatial information database. The environmental information may indicate a search range for the access-requested resource.

For example, when a user named Hong Gil-dong wants to receive a road information service for an area within 2 km from Sejong center in a road information map, the request for access may be configured in the context of “user: Hong Gil-dong, operation: road information service, resource: road information map, environment: within 2 km from Sejong center”.

The access authority information obtaining unit 111 obtains corresponding access authority information by referring to the spatial information authority database 10 based on the user identification information and resource included in the user's request for access. For example, the access authority information obtaining unit 111 obtains information on what resource the user has the authority to access.

The access authority information judging unit 113 determines whether to permit the operation included in the request for access by referring to the allowable range included in the obtained access authority information. For example, the access authority information judging unit 113 determines whether there is the authority to receive the requested service with respect to the accessible resource.

The access permission determining unit 115 determines whether to permit the user to access the requested spatial information service based on the access permission judgment result.

Like in the above embodiment, when the request for access of “user: Hong Gil-dong, operation: road information service, resource: road information map, environment: within 2 km from Sejong center” is received, the access permission determining unit 115 determines whether Hong Gil-dong has the authority to receive the “road information service” for the “road information map”, and determines whether to permit Hong Gil-dong to access the corresponding service. For example, while Hong Gil-dong has only the authority to receive the road information service, if he requests a traffic jam area information service, the traffic jam area information service will be rejected.

The spatial information database 20 stores data related to the spatial information service. The spatial information data related to the spatial information service includes a resource identifiably stored and at least one attribute for the resource. For example, if the spatial information is map information, the resource may be a military secret map stored in the form of a map, and the attribute may be data obtained by digitizing information on each position in the map.

The service providing unit 140 activated by the user's request for access to the spatial information service comprises the service configuring unit 141 and the service interface providing unit 143.

The service configuring unit 141 obtains the data related to the spatial information service corresponding to the user's request for access from the spatial information database 20 and configures the service based on the user's request for access.

For example, when a request for access of “user: Hong Gil-dong, operation: road information service, resource: road information map, environment: within 2 km from Sejong center” is received, the service configuring unit 141 obtains the requested road information map from the spatial information database 20, extracts data for an area within 2 km from Sejong center from the obtained map, and organizes the service in the form of a binary encoding, extensible markup language (XML), geography markup language (GML) or link, and then transmits the service to the access control unit 150.

The service interface providing unit 143 provides an interface for providing the configured spatial information service to the user.

The access control unit 150 allocates the request for access to the spatial information service from the user, controls the activation of the service providing unit 140, and controls an interface between the service configuring unit 141 and the service interface providing unit 143.

That is, for example, when the user's request for access to the spatial information data is a request for a service, the access control unit 150 performs a series of control operations such as activating the service providing unit 140, requesting the access authority determining unit 110 to identify the access authority in response to the user's request for access, requesting the service interface providing unit 143 to configure an interface for the service configured by the service configuring unit 141, and providing the service interface to the user.

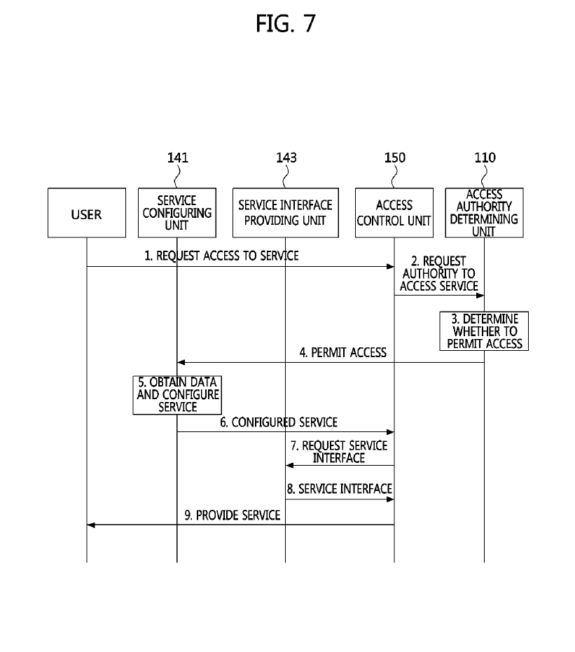

FIG. 7 is a sequence chart showing the flow and processing of data in an apparatus for protecting a spatial information service in accordance with still another exemplary embodiment of the present invention.

Referring to FIGS. 6 and 7, a process of receiving a request for access to a spatial information service and providing the spatial information service to the user in accordance with still another exemplary embodiment of the present invention may be described as follows.

When a request for access to a spatial information service is received from a user, the access control unit 150 activates the service providing unit 140, forms a context corresponding to the user's request for access, and transmits the context to the access authority determining unit 110. That is, the access control unit 150 inquires whether to permit the user to access the spatial information service requested by the user. Like in the above embodiment, when a user named Hong Gil-dong wants to receive a road information service for an area within 2 km from Sejong center in a road information map, the request for access will be configured in the context of “user: Hong Gil-dong, operation: road information service, resource: road information map, environment: within 2 km from Sejong center”, and transmitted to the access authority determining unit 110.

The access authority determining unit 110, which receives the inquiry on whether to permit the user's request for access from the access control unit 150, refers to the access authority information from the spatial information authority database 10 storing the access authority information and, if the user has the authority to access the requested spatial information service, requests the service configuring unit 141 to obtain the data related to the requested service.

Regarding the aforementioned request for access of “user: Hong Gil-dong, operation: road information service, resource: road information map, environment: within 2 km from Sejong center”, the access authority determining unit 110 determines whether Hong Gil-dong has the authority to receive the “road information service” for the “road information map”, determines whether to permit Hong Gil-dong to access the corresponding service, and requests the service configuring unit 141 to configure the service of “resource: road information map, environment: within 2 km from Sejong center”.

The service configuring unit 141 obtains data related to the access-permitted spatial information service from the spatial information database 20, organizes the data based on the user's request for access, and then returns the data to the access control unit 150. Here, the data may be organized in the form of a binary encoding, extensible markup language (XML), geography markup language (GML) or link.

The access control unit 150 receiving the organized data transmits the context of the user's request for access and the service configured by the service configuring unit 141 to the service interface providing unit 143 and requests the service configuring unit 141 to configure a service interface for the corresponding service. The service interface configured by the service interface providing unit 143 is provided as a service to the user through the access control unit 150.

Configuration and Operation of Apparatus for Protecting Previously Extracted Spatial Information Data

In the foregoing embodiments, when a user requests an access to the spatial information data, the access authority information of the requesting user is first identified and, only when the user has the authority to access the requested spatial information, the spatial information data is provided to the user.

However, in the following embodiment, under the condition that data for each user is previously extracted from a spatial information database and stored, when there is a request from a user, the requested spatial information data is provided to the user without identifying the access authority, and then when the user requests an access to the data, a license is issued to control the user's access to the data.

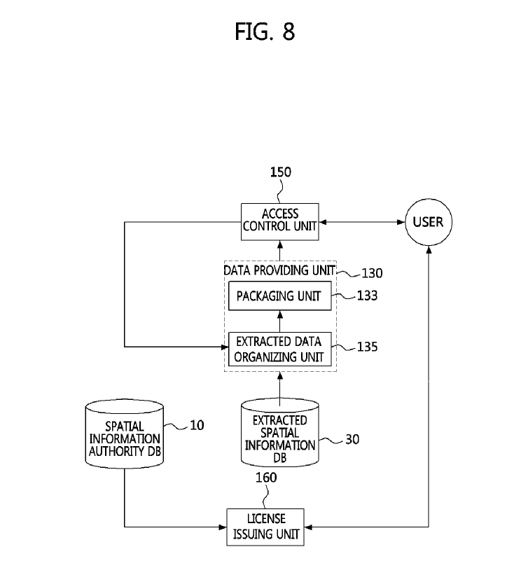

FIG. 8 is a block diagram showing the configuration of an apparatus for providing previously extracted spatial information data in accordance with yet another exemplary embodiment of the present invention.

Referring to FIG. 8, it can be seen that the apparatus for providing the previously extracted spatial information data in accordance with yet another exemplary embodiment of the present invention comprises a spatial information authority database 10, an extracted spatial information database 30, an extracted data organizing unit 135, an packaging unit 133, an access control unit 150, and a license issuing unit 160.

Referring to FIG. 8, the configuration of the apparatus for providing the previously extracted spatial information data in accordance with yet another exemplary embodiment of the present invention may be described as follows.

Access authority information on spatial information is stored in the spatial information authority database 10. The access authority information may include a resource accessible by each user and an allowable range for the resource. The allowable range may include, for example, the authority to refer to the resource, the authority to edit the resource, the authority to modify the resource, the authority to generate the resource, etc.

The extracted spatial information database 30 stores the spatial information data which is previously extracted from the spatial information authority database 10.

The data providing unit 130 comprises the extracted data organizing unit 135 and the packaging unit 133.

The extracted data organizing unit 135 obtains the spatial information data corresponding to the user's request for access from the extracted spatial information database 30 and organizes the spatial information data based on the user's request for access.

The packaging unit 133 packages the organized spatial information data. Here, the spatial information data may be packaged by the packaging unit 133 in the form of a binary file, to which digital rights management (DRM) is applied, to prevent illegal copy of the spatial information data organized by the extracted data organizing unit 135.

The packaged spatial information data is provided to the user under the control of the access control unit 150.

The access control unit 150 allocates the request for access to the spatial information data from the user, controls the activation of the extracted data organizing unit 135 and controls an interface between the extracted data organizing unit 135 and the packaging unit 133.

That is, for example, when the user's request for access to the spatial information data is a request for extracted data, the extracted data organizing unit 135 and the packaging unit 133 of the data providing unit 130 are activated. The access control unit 150 performs a series of control operations such as requesting the access authority determining unit 110 to identify the access authority in response to the user's request for access, requesting the packaging unit 133 to package the data organized by the extracted data organizing unit 135, and providing the data packaged by the packaging unit 133 to the user.

In response to the request for access from the user who receives the packaged data generated by the packaging unit 133, the license issuing unit 160 issues a license to the user such that the user can access the packaged spatial information data. The configuration of the license issuing unit 160 is the same as that of the license issuing unit 160 of FIG. 4.

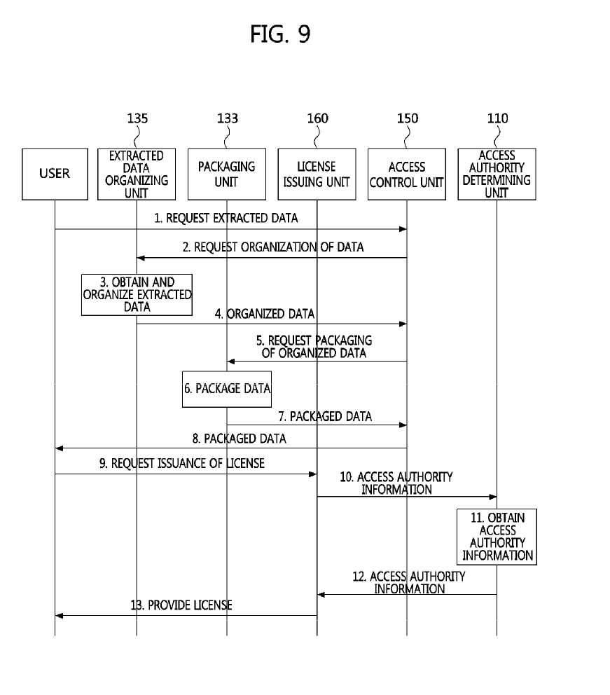

FIG. 9 is a sequence chart showing the flow and processing of data in the apparatus for providing the previously extracted spatial information data in accordance with yet another exemplary embodiment of the present invention.

Referring to FIGS. 8 and 9, a process of receiving a request for access to previously extracted data and providing the previously extracted data to the user may be described as follows.

When a request for access to a spatial information service is received from a user, the access control unit 150 transmits the user's request for access to the extracted data organizing unit 135 and requests the extracted data organizing unit 135 to obtain the requested data.

Unlike the embodiments described with reference to FIGS. 5 and 7, in which only the spatial information (e.g., the spatial information except for a road map when the user can access only a house map of Gangnam-gu, Seoul) requested by the user is extracted and provided, in the present embodiment, all spatial information (such as the house map and road map, which are previously extracted and separately stored) included in the corresponding area requested by the user is packaged based on the user's request and transmitted to the user.

In this case, unlike the foregoing embodiments, the user can access the data at a time when the user uses the corresponding data based on the license issued to the user without identifying the access authority.

The extracted data organizing unit 135 obtains the requested extracted spatial information data from the extracted spatial information database 30, organizes the extracted spatial information data based on the user's request for access, and then returns the data to the access control unit 150. Here, the data may be organized in the form of a binary encoding, extensible markup language (XML), geography markup language (GML) or link.

The access control unit 150 receiving the organized extracted data transmits the context of the user's request for access and the data organized by the extracted data organizing unit 135 to the packaging unit 133 and requests the packaging unit 133 to package the data.

The packaging unit 133 packages the received data and returns the data to the access control unit 150. The access control unit 150 receiving the packaged data transmits the packaged data to the user who requests the access.

Meanwhile, when the user receiving the packaged data requests the license issuing unit 160 to issue a license to use the packaged data, the license issuing unit 160 obtains authority information on the requested user's packaged data from the spatial information authority database 10, generates the license by organizing the obtained authority information as the license, and provides the license to the requesting user.

As described above, according to the apparatus and method for protecting the digital spatial information in accordance with the exemplary embodiments of the present invention, it is possible to protect the digital spatial information itself and further control the digital spatial information such that an unauthorized user cannot use the digital spatial information even when a protection is removed from the corresponding information during distribution, thereby doubly protecting the digital spatial information.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. An apparatus for protecting digital spatial information, the apparatus comprising:
a spatial information authority database which stores access authority information on spatial information;
an access authority determining unit which, when there is a request for access to the spatial information from a user, determines whether to permit the user to access the requested spatial information by referring to the spatial information authority database;
a spatial information database which stores the spatial information;
a spatial information providing unit which obtains the access-permitted spatial information from the spatial information database, organizes the information based on the user's request for access, and provides the information; and
an access control unit which controls an interface between the access authority determining unit, the spatial information providing unit, and the user according to the type of the user's request for access.

2. The apparatus of claim 1, wherein the type of the user's request for access comprises a request for access to spatial information data, a request for access to a spatial information service, and a request for access to previously extracted spatial information data.

3. The apparatus of claim 2, wherein the spatial information providing unit comprises a data providing unit and a service providing unit,
wherein, when the type of the user's request for access is the request for access to the spatial information data or the request for access to the previously extracted spatial information data, the data providing unit is activated by the access control unit, and
wherein, when the type of the user's request for access is the request for access to the spatial information service, the service providing unit is activated by the access control unit.

4. The apparatus of claim 3, wherein the data providing unit comprises:
a data organizing unit which obtains the access-permitted spatial information data from the spatial information database, extracts a predetermined portion from the obtained spatial information data, and organizes the spatial information data based on the user's request for access; and
a packaging unit which packages the organized spatial information data,
wherein an interface between the data organizing unit and the packaging unit is controlled by the access control unit.

5. The apparatus of claim 4, wherein the data providing unit further comprises:
an extracted spatial information database which stores data randomly extracted in advance from the spatial information database; and
an extracted data organizing unit which obtains the spatial information data extracted from the extracted spatial information database and organizes the spatial information data based on the user's request for access,
wherein an interface between the extracted data organizing unit and the packaging unit is controlled by the access control unit.

6. The apparatus of claim 5, wherein, when the type of the user's request for access is the request for the spatial information data, the data organizing unit is activated by the access control unit and the packaging unit packages the spatial information data organized by the data organizing unit, and
wherein, when the type of the user's request for access is the request for the extracted spatial information data, the extracted data organizing unit is activated by the access control unit and the packaging unit packages the extracted spatial information data organized by the extracted data organizing unit.

7. The apparatus of claim 6, further comprising a license issuing unit which issues a license to a user in response to the request for access from the user who receives the packaged data,
wherein the license issuing unit comprises:
a license issue request receiving unit which receives a request for issuing a license from the user who receives the packaged data;
an access authority obtaining unit which obtains authority information on the packaged data with respect to the requesting user from the spatial information authority database;
a license generating unit which generates a license by organizing the obtained access authority information as the license; and
a license providing unit which provides the generated license to the user.

8. The apparatus of claim 3, wherein the service providing unit comprises:
a service configuring unit which obtains spatial information data related to the access-permitted spatial information service from the spatial information database, extracts a predetermined portion from the spatial information service, and configures the spatial information service based on the user's request for access; and
a service interface providing unit which provides a service interface for providing the configured spatial information service,
wherein an interface between the service configuring unit and the service interface providing unit is controlled by the access control unit.

9. The apparatus of claim 1, wherein the access authority information stored in the spatial information authority database comprises the authority to access a resource for each user, and wherein the authority to access the resource for each user comprises a user, at least one resource which is accessible by the user, and an allowable range for access to the resource.

10. The apparatus of claim 9, wherein the request for access to the spatial information comprises:
user identification information of a user requesting the access to the spatial information;
an operation which indicates a specific action related to manipulation applied to the access-requested spatial information;
at least one resource which corresponds to a main target of the access-requested spatial information and is identifiably stored in the spatial information database; and
environmental information which indicates a limited search range for the resources.

11. The apparatus of claim 10, wherein the access authority determining unit comprises:
an access authority information obtaining unit which obtains corresponding access authority information by referring to the spatial information authority database based on the user identification information and the resources included in the user's request for access;
an access authority information judging unit which determines whether to permit the operation included in the request for access by referring to the allowable range for access to the requested resource included in the obtained access authority information; and
an access permission determining unit which determines whether to permit the user to access the requested spatial information based on the access permission judgment result.

12. The apparatus of claim 11, wherein the spatial information stored in the spatial information database comprises spatial information data, and wherein the spatial information data comprises a resource identifiably stored and at least one attribute for the resource.

13. The apparatus of claim 1, wherein the spatial information obtained by the spatial information providing unit is organized based on the request for access in the form of a binary encoding, extensible markup language (XML), geography markup language (GML) or link.

14. The apparatus of claim 4, wherein the spatial information data is packaged by the packaging unit in the form of a binary file, to which digital rights management (DRM) is applied, to prevent illegal copy of the spatial information data organized by the data organizing unit.

15. The apparatus of claim 1, wherein the spatial information comprises map information, and wherein the map information stored in the spatial information database comprises map identification information, a map related to the identified map information, and information obtained by digitizing positions in the map.

16. A method for protecting spatial information data, which is performed in an apparatus for protecting digital spatial information, the method comprising:
receiving a request for access to spatial information data from a user;
obtaining the user's authority to access the spatial information data corresponding to the user's request for access from a spatial information authority database;
determining whether to permit the user to access the requested spatial information data by referring to the obtained access authority and, if it is determined that the requesting user has the authority to access the spatial information data, permitting the user to access the corresponding spatial information data;
obtaining the access-permitted spatial information data from the spatial information authority database;
organizing the spatial information data by extracting necessary information from the obtained spatial information data based on the user's request for access;
packaging the organized data to be protected; and
transmitting the packaged data to the user.

17. A method for protecting a spatial information service, which is performed in an apparatus for protecting digital spatial information, the method comprising:
receiving a request for access to a spatial information service from a user;
obtaining the user's authority to access the spatial information service corresponding to the user's request for access from a spatial information authority database;
determining whether to permit the user to access data related to the requested spatial information service by referring to the obtained access authority and, if it is determined that the requesting user has the authority to access the spatial information service, permitting the user to access the corresponding spatial information service;
obtaining data related to the access-permitted spatial information service from the spatial information authority database;
configuring a necessary information service using the obtained spatial information data based on the user's request for access; and
providing the configured service to the user.

18. A method for protecting previously extracted spatial information data, which is performed in an apparatus for protecting digital spatial information, the method comprising:
receiving a request for access to previously extracted spatial information data from a user;
obtaining the previously extracted spatial information data corresponding to the user's request to access from a spatial information authority database and organizing the previously extracted spatial information data based on the user's request for access;
packaging the organized data to be protected; and
transmitting the packaged data to the user.

19. A method for issuing a license to a user, which is performed in an apparatus for protecting digital spatial information, the method comprising:
receiving a request for issuing a license for access to spatial information from a user who receives the spatial information from the apparatus for protecting the digital spatial information;
obtaining access authority information on the spatial information provided to the user from a spatial information authority database;
generating a license by organizing the obtained access authority information as the license; and
providing the generated license to the user.
